(19) United States
(12) Patent Application Publication
(10) Pub. No.: US 2026/0159317 A1
(43) Pub. Date: Jun. 11, 2026

(54) SHELF ROBOT AND CONTROL OF SUCH A SHELF ROBOT

(71) Applicant: Volkswagen Aktiengesellschaft, Wolfsburg (DE)

(72) Inventors: Falk Ebert, Wolfsburg (DE); Jan Borowski, Wolfsburg (DE)

(21) Appl. No.: 19/402,467

(22) Filed: Nov. 26, 2025

(30) Foreign Application Priority Data
Dec. 6, 2024 (DE) 102024136434.3

(51) Int. Cl. B65G 1/04; B25J 5/00; B25J 9/02; B25J 9/16; B25J 18/02

(52) U.S. Cl. CPC B65G 1/0435; B25J 9/1697; B25J 18/025; B65G 1/0421; B25J 5/007; B25J 9/023

(57) ABSTRACT

A shelf robot suitable for a small warehouse is disclosed. The shelf robot includes a base assembly having a drive unit, a storage assembly including at least one storage unit for storing an item to be transported, and a manipulator assembly configured to manipulate an item to be transported. The manipulator assembly is configured to move the item along a first horizontal linear axis Aₓ from a shelf storage spot into a vertical transport region and to move the item along a second horizontal linear axis A_{y}, which is perpendicular to the first horizontal linear axis Aₓ, from the vertical transport region to a storage unit of the storage assembly. Related methods, a computer program including instructions for operating the shelf robot, and a control device configured to execute such instructions are also disclosed.

### RELATED APPLICATIONS

The present application claims priority to German Patent Application No. DE 10 2024 136 434.3, to Ebert et al., filed Dec. 6, 2024, the contents of which is incorporated by reference in its entirety herein.

### TECHNICAL FIELD

The present disclosure relates to a shelf robot, and in particular to a shelf robot suitable for use in a small warehouse. The present disclosure furthermore relates to a method, to a computer program including instructions, and to a control device for operating such a shelf robot.

### BACKGROUND

In the field of logistics, robots are increasingly used to transport and handle boxes or cartons, for example to store these on shelves or remove them from shelves. Much of the development activity in this field has been directed toward robotic systems designed for large warehouses.

Automated transport of items would also be advantageous for smaller warehouse environments, such as those typically found in workshops or tradesmen's facilities. However, such small warehouses generally include narrow aisles having widths between approximately 0.9 m and 1.0 m and heights of approximately 2.1 m. Standard robotic solutions designed for large-scale warehouse operations are often too large to navigate these narrow aisles or to turn around in the access areas. In addition, they typically do not fit through standard interior doors, which often have a height of approximately 2.0 m. As a result, existing systems are not well suited for the physical constraints of small warehouses.

Against this background, DE 20 2018 006 834 U1 describes a robot comprising a traveling device, a body arranged above the traveling device, a receiving device arranged above the body, and an object gripping device. The receiving device includes a receiving space with multiple compartments arranged one above another.

DE 20 2019 005 946 U1 describes a handling robot comprising a moving chassis, an intermediate storage rack arranged on the moving chassis, a lifting adjustment system arranged on the moving chassis, a box removal system that can be extended horizontally relative to the moving chassis, and a telescopic adjustment system arranged on the lifting adjustment system and connected to the box removal system.

EP 3 372 541 B1 describes a robot for gripping and transporting objects. The robot comprises a frame and a gripping unit, wherein the gripping unit is configured to assume various vertical positions relative to the frame in an operational configuration.

Aspects of the present disclosure relate to providing an improved shelf robot suitable for use in a small warehouse, as well as solutions for controlling such a shelf robot.

Some aspects of a shelf robot, a control device, and related methods are reflected in the features of the independent claims found below. Additional aspects are set forth in the subject matter of the dependent claims.

In some examples, a shelf robot for a small warehouse is disclosed, comprising: a base assembly including a drive unit; a storage assembly including at least one storage unit for storing an item to be transported; and a manipulator assembly for manipulating an item to be transported. The manipulator assembly is configured to move the item to be transported along a first horizontal linear axis from a shelf storage spot into a vertical transport region, and along a second horizontal linear axis, which is perpendicular to the first horizontal linear axis, from the vertical transport region to a storage unit of the storage assembly.

In some examples, a method is disclosed for controlling a shelf robot, the method comprising: moving an item to be transported along a first horizontal linear axis from a shelf storage spot into a vertical transport region of the shelf robot; when necessary, moving the item to be transported within the vertical transport region along a vertical linear axis; and moving the item to be transported along a second horizontal linear axis, which is perpendicular to the first horizontal linear axis, from the vertical transport region to a storage unit of a storage assembly of the shelf robot.

In some examples, a computer program is disclosed including instructions that, when executed by a computer, prompt the computer to carry out steps for controlling a shelf robot, the steps comprising: moving an item to be transported along a first horizontal linear axis from a shelf storage spot into a vertical transport region of the shelf robot; when necessary, moving the item to be transported within the vertical transport region along a vertical linear axis; and moving the item to be transported along a second horizontal linear axis, which is perpendicular to the first horizontal linear axis, from the vertical transport region to a storage unit of a storage assembly of the shelf robot.

As used herein, the term “computer” is to be understood broadly and includes control devices, embedded systems, and other processor-based data processing devices. The individual steps of the computer program need not be carried out directly by the computer itself; the computer may activate or utilize external components to perform one or more steps.

The computer program can be provided for electronic retrieval or stored on a computer-readable memory medium.

In some examples, a control device is disclosed for a shelf robot, the control device comprising a memory storing instructions and a processor. The processor is configured to carry out steps for controlling a shelf robot when executing the instructions, the steps comprising: moving an item to be transported along a first horizontal linear axis from a shelf storage spot into a vertical transport region of the shelf robot; when necessary, moving the item to be transported within the vertical transport region along a vertical linear axis; and moving the item to be transported along a second horizontal linear axis, which is perpendicular to the first horizontal linear axis, from the vertical transport region to a storage unit of a storage assembly of the shelf robot.

### BRIEF DESCRIPTION OF THE DRAWINGS

Further features of the present disclosure can be derived from the following description and the accompanying claims, in conjunction with the figures.

FIG. 1 schematically shows a floor plan of a workshop including a small warehouse, according to some aspects of the present disclosure.

FIG. 2 schematically shows shelves of a small warehouse, according to some aspects of the present disclosure.

FIG. 3 schematically shows a shelf robot, according to some aspects of the present disclosure.

FIG. 4 schematically shows a method for controlling a shelf robot, according to some aspects of the present disclosure.

FIG. 5 schematically shows a control device for a shelf robot, according to some aspects of the present disclosure.

FIG. 6 shows a first view of a specific embodiment of a shelf robot, according to some aspects of the present disclosure.

FIG. 7 shows a second view of the shelf robot of FIG. 6, according to some aspects of the present disclosure.

### DETAILED DESCRIPTION

To provide a better understanding of principles of the present disclosure, specific examples are described in greater detail below with reference to the figures. It shall be understood that the present disclosure is not limited to these specific examples, and that the described features can be combined or modified without departing from the scope defined by the accompanying claims.

In the examples disclosed herein, the shelf robot is configured with a storage assembly including at least one storage unit. To transfer an item to be transported into this storage unit, the item is moved along a horizontal linear axis arranged perpendicular to another horizontal linear axis along which the item is retrieved from or placed into a shelf. This arrangement of linear axes enables a compact design. Nevertheless, at least two items can be transported concurrently—one positioned in the storage unit and another positioned within the vertical transport region. When established small-load carriers having horizontal dimensions of approximately 0.4 m×0.6 m are used, the shelf robot may have a footprint of approximately 0.8 m in width and 1.0 m in length.

In some examples, the manipulator assembly is configured to move an item within the vertical transport region along a vertical linear axis. By enabling movement along this vertical axis, the shelf robot can retrieve items from different shelf heights and transfer them to the storage unit. More than one item may be retrieved from a given shelf height. Despite being capable of accessing higher shelves, the overall height of the shelf robot can remain relatively small—approximately 1.7 m—allowing the robot to pass through standard interior doors.

In some examples, the vertical transport region is located within a footprint of the base assembly. This configuration allows the shelf robot to be implemented in an extremely compact manner. At the same time, the robot can remain stable and easy to maneuver because no protruding components extend beyond the base assembly during movement.

In some examples, the first horizontal linear axis is perpendicular to a main direction of movement of the shelf robot. This lateral loading and unloading capability eliminates the need for a precise, complex positioning procedure in front of a shelf compartment. Positioning inaccuracies can be readily compensated by moving the manipulator assembly along the second horizontal linear axis.

In some examples, the storage assembly comprises two or more storage units arranged one above another to form a shelf-like structure. This arrangement enables the simultaneous transport of more than two items. In addition, items can be sorted on the shelf robot according to height, priority, or other criteria.

In some examples, the height of at least one of the storage units can be adjusted manually or by a motorized mechanism. This is advantageous when items of different heights are handled, for example when transporting boxes of varying dimensions or when the contents of a box extend beyond the upper edge of the box.

In some examples, the manipulator assembly comprises a telescopic gripper configured for gripping an item to be transported. To grip the item, the telescoping mechanism can extend past the item. In the extended state, two locking elements may be engaged, and when the telescoping mechanism retracts, the item is pulled along.

In some examples, the telescopic gripper comprises gripping elements having an adjustable spacing, which can be set manually or by a motorized mechanism. This allows the shelf robot to grip items having different widths.

In some examples, the manipulator assembly comprises a deposit area for supporting an item to be transported. Mechanical pulling and pushing can be used for storing and retrieving items. The deposit area bears the weight of the item, reducing mechanical stability requirements for the pulling and pushing mechanism.

In some examples, the shelf robot comprises a housing assembly for accommodating the storage assembly and the manipulator assembly. The housing assembly provides protection for the components of the shelf robot as well as for items being transported.

In some examples, the shelf robot comprises a sensor system for sensing an environment of the robot. The sensor system can be configured to detect the position or dimensions of an item located in a shelf or to identify obstacles during robot movement. The sensor system may utilize camera systems, LIDAR sensors, ultrasonic sensors, light barriers, or other suitable sensors.

In some examples, the shelf robot is configured to operate autonomously or under control of a central unit. The appropriate control mode may depend on factors such as the application environment or available budget. Hybrid approaches are also possible; for example, movement of the shelf robot within the small warehouse may be coordinated by a central unit, while handling of items during loading or unloading may be performed autonomously.

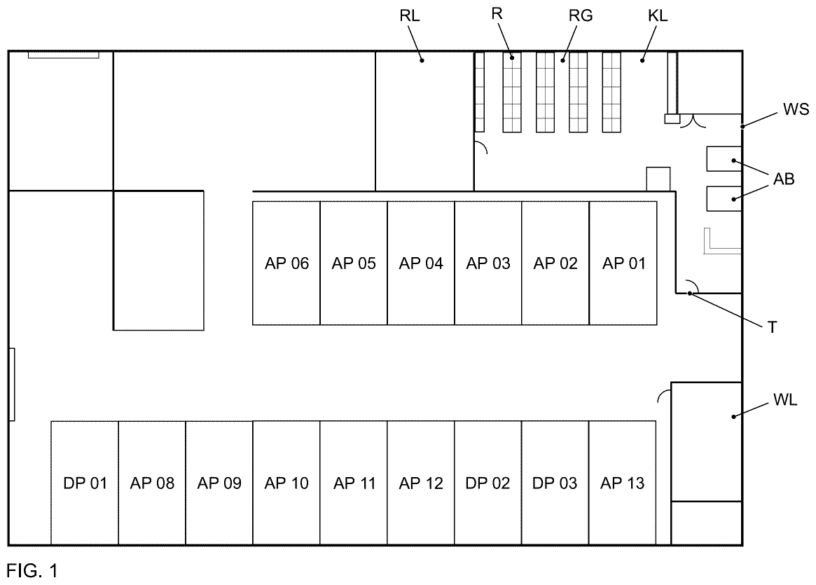

FIG. 1 schematically shows a floor plan of a workshop WS including a small warehouse KL. The workshop WS, which in this example is a motor-vehicle repair shop, includes a number of workstations AP and diagnostic stations DP. Also shown are a tire storage area RL, rooms WL for workshop management, and several work areas AB for the employees. The small warehouse KL includes a number of shelves R having corresponding shelf storage spots LP. Items to be transported—such as small load carriers or boxes containing spare parts—must be transported from the small warehouse KL to the workstations AP. It can be seen that the aisles RG of the small warehouse KL are quite narrow, typically having a width between approximately 0.9 m and 1.0 m. In addition, a door T must be passed on the way to the workstations AP, and such a door T usually has a height of approximately 2.0 m. Standard shelf robots are too large to navigate such aisles RG, to turn around in these access areas, and they typically do not fit through the door T.

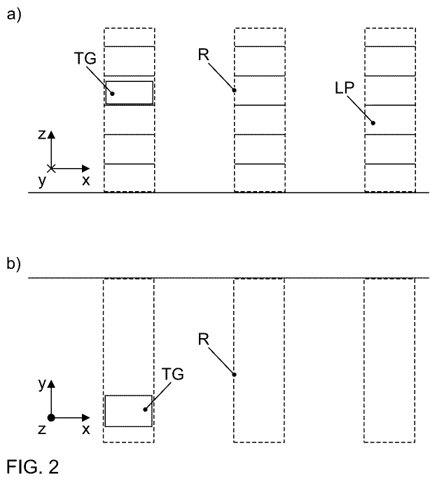

FIG. 2 schematically shows several shelves R of a small warehouse. FIG. 2a) shows a view from the side or shelf-head side, and FIG. 2 b) shows a view from above. The shelves R are standard shelves having flat sheet-metal compartments in which items to be transported TG are placed, such as boxes containing individual picking orders. Each item TG is located at an assigned shelf storage spot LP, which can be uniquely identified by a shelf number, a shelf level, and a position within that shelf level.

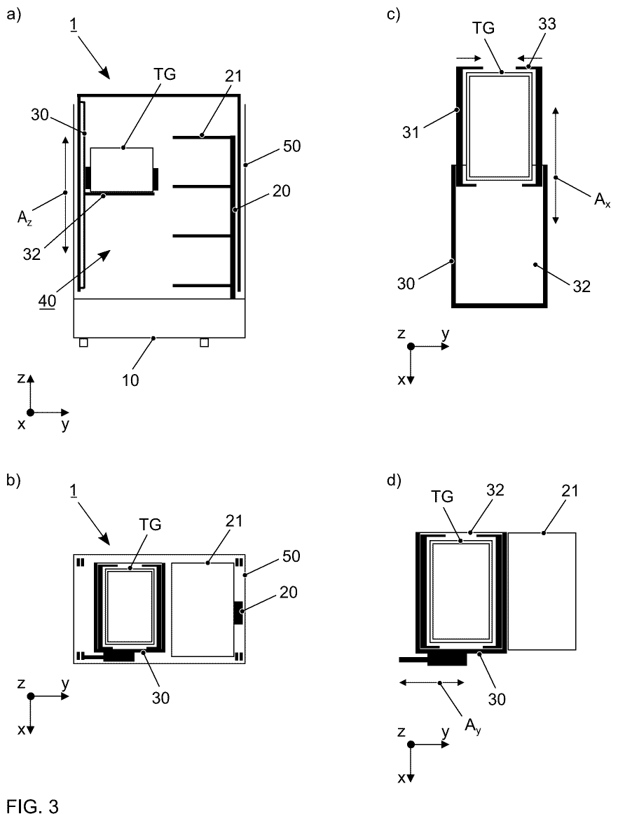

FIG. 3 schematically shows an example of a shelf robot 1 for a small warehouse. FIG. 3a) shows a side view, and FIG. 3b) shows a top view. The shelf robot 1 comprises a base assembly 10 in which a drive unit (not shown) is arranged. The drive unit may comprise wheels, a motor for driving the wheels, and an energy storage device. A storage assembly 20 is arranged on the base assembly 10. The storage assembly 20 includes at least one storage unit 21 for storing an item TG. In the example shown in FIG. 3, the storage assembly 20 includes four storage units 21 in the form of storage compartments. A manipulator assembly 30 is arranged on the base assembly 10 adjacent to the storage assembly 20. The manipulator assembly 30 is configured to manipulate an item TG. In particular, the manipulator assembly 30 is configured to move the item TG along a first horizontal linear axis Aₓ from a shelf storage spot into a vertical transport region 40. The manipulator assembly 30 is further configured to move the item TG along a second horizontal linear axis A_{y}, which is perpendicular to the first horizontal linear axis Aₓ, from the vertical transport region 40 to a storage unit 21 of the storage assembly 20. This is shown schematically in FIGS. 3c) and 3d). Within the vertical transport region 40, the manipulator assembly 30 can additionally move the item TG along a vertical linear axis A_{z} to align the item with the height of a desired storage unit 21. The three Cartesian linear axes Aₓ, A_{y}, A_{z} enable a very compact structural design. A housing assembly 50, partially illustrated, accommodates the storage assembly 20 and the manipulator assembly 30 and protects the robot components and the transported items.

In this example of the shelf robot 1, mechanical pulling and pushing of the item TG (e.g., the box) is used for storage and retrieval. A telescopic gripper 31 extends and passes the box, and in the extended state two locks 33 can engage. When the telescopic gripper 31 retracts, the box is drawn onto a deposit area 32. For retrieval, the box can be pushed outward by a fixed mechanism. On the shelf robot 1, the box is transported laterally by sideways movement of the telescopic gripper 31. At the storage position, the telescopic gripper 31 is moved vertically until positioned above the deposited box and then retracted. Retrieval takes place in the reverse sequence.

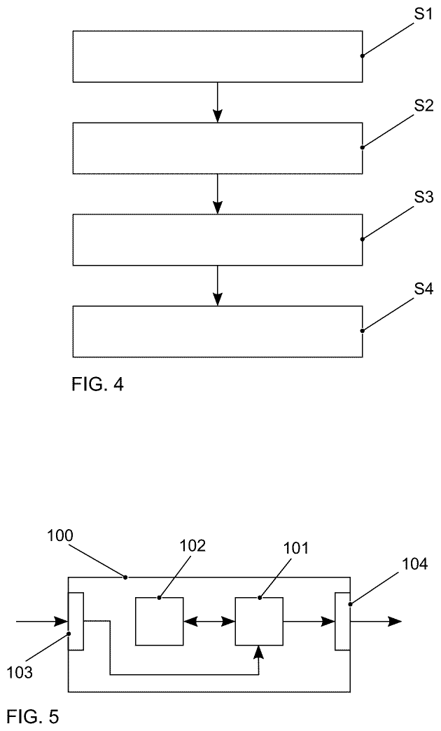

FIG. 4 schematically shows a method for controlling a shelf robot 1. In a first step S1, an item is moved along a first horizontal linear axis from a shelf storage spot into a vertical transport region of the shelf robot. If necessary, the item is then moved S2 within the vertical transport region along a vertical linear axis so as to bring it to a desired height. Optionally, a storage unit may be displaced S3 to the desired height. Finally, the item is moved S4 along a second horizontal linear axis, which is perpendicular to the first horizontal linear axis, from the vertical transport region to a storage unit of a storage assembly of the shelf robot.

FIG. 5 shows a simplified schematic representation of a control device 100 for a shelf robot, configured to carry out the method of FIG. 4. The control device 100 comprises a processor 101 and a memory 102. Instructions stored in the memory 102 prompt the control device 100, when executed by the processor 101, to carry out the steps of the described method. The instructions stored in the memory 102 therefore implement a program executable by the processor 101. The control device 100 includes an input 103 for receiving data, and an output 104 for providing data generated by the processor 101. Data may also be stored in the memory 102. The input 103 and the output 104 may be combined to form a bidirectional interface.

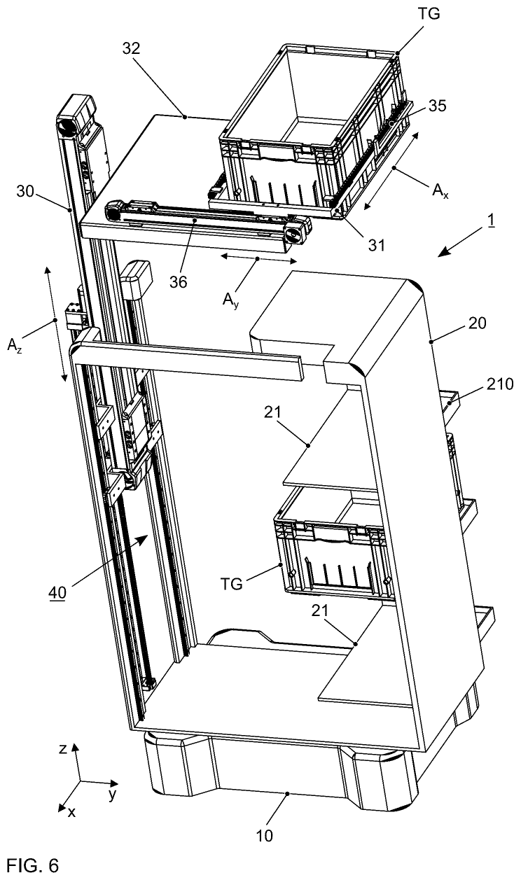

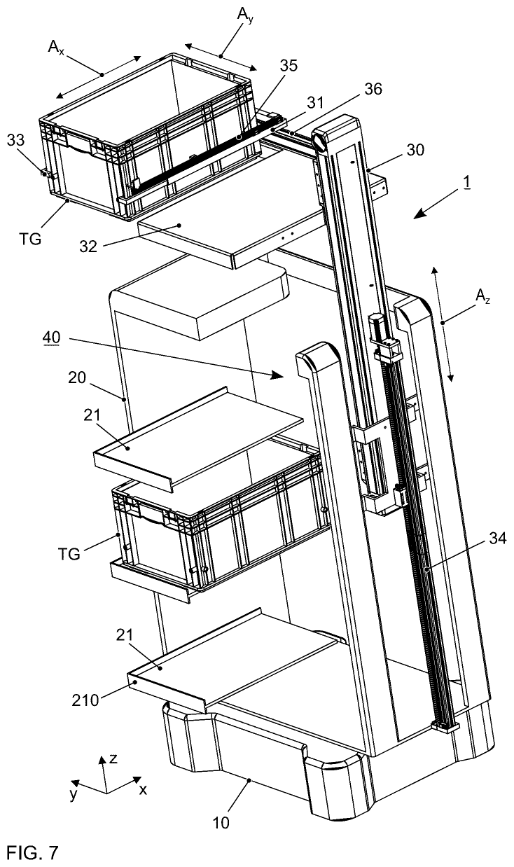

A preferred specific example will now be described with reference to FIGS. 6 and 7.

FIG. 6 and FIG. 7 show two oblique views of a preferred specific example of a shelf robot 1. The shelf robot 1 comprises a base assembly 10. A drive unit, not visible in these figures, is arranged in the base assembly 10 and comprises steerable wheels, a motor for driving the wheels, and an energy storage device. A storage assembly 20 is arranged on the base assembly 10. The storage assembly 20 includes three storage units 21 for storing box-shaped items TG. Each storage unit 21 is a storage compartment including a partial border 210, which secures the items TG during transport. A manipulator assembly 30 is arranged on the base assembly 10 adjacent to the storage assembly 20. The manipulator assembly 30 is configured to manipulate an item TG and to move the item TG along a first horizontal linear axis Aₓ from a shelf storage spot into a vertical transport region 40. For this purpose, a telescoping mechanism 36 designed as a telescopic gripper 31 pulls the item TG onto a deposit area 32.

Within the vertical transport region 40, the manipulator assembly 30 can move the item TG by means of a spindle drive 34 along a vertical linear axis A_{z} to bring the item to the height of a desired storage unit 21. When the item TG is located at the desired height, it can be pushed together with the telescopic gripper 31—by means of a linear slide 35 along a second horizontal linear axis A_{y}, which is perpendicular to the first horizontal linear axis Aₓ, from the vertical transport region 40 onto the corresponding storage unit 21. Mechanical pulling and pushing is used for both storage and retrieval. The telescopic gripper 31 extends and moves past the box, where in this example two locks 33 may engage in the extended state, as indicated in FIG. 7. When the telescopic gripper 31 retracts, the item TG is pulled onto the deposit area 32. On the shelf robot 1, the box is displaced laterally by movement of the telescopic gripper 31. At the storage position, the telescopic gripper 31 is moved vertically by the spindle drive 34 until it is above the deposited item TG and is then retracted by the linear slide 35. Retrieval takes place in the reverse order.

The shelf robot 1 preferably includes a sensor system (not shown) for sensing its environment. In particular, the sensor system may detect the position or dimensions of an item TG in a shelf or may detect obstacles during movement of the shelf robot 1. The sensor system may include camera systems, LIDAR sensors, ultrasonic sensors, light barriers, or other suitable sensing devices.

### List of Reference Signs

1 shelf robot
10 base assembly
20 storage assembly
21 storage unit
210 partial border
30 manipulator assembly
31 telescopic gripper
310 gripping element
32 deposit area
33 lock
34 spindle drive
35 linear slide
36 telescoping mechanism
40 vertical transport region
50 housing assembly
100 control device
101 processor
102 memory
103 input
104 output
Aₓ first horizontal linear axis
A_{y} second horizontal linear axis
A_{z} vertical linear axis
AB work area
AP workstation
DP diagnostic station
KL small warehouse
LP shelf storage spot
R shelf
RG aisle
RL tire storage area
T door
TG item to be transported
WL workshop management
WS workshop
S1 moving an item to be transported from a shelf storage spot into a vertical transport region
S2 moving the item to be transported within the vertical transport region
S3 adjusting the height of a storage unit
S4 moving the item to be transported from the vertical transport region to a storage unit

1. A shelf robot, comprising:
a base assembly comprising a drive unit;
a storage assembly comprising at least one storage unit configured to store an item to be transported; and
a manipulator assembly configured to manipulate the item to be transported,
wherein the manipulator assembly is configured to move the item to be transported along a first horizontal linear axis Aₓ from a shelf storage spot into a vertical transport region,
and wherein the manipulator assembly is further configured to move the item to be transported along a second horizontal linear axis A_{y}, which is perpendicular to the first horizontal linear axis Aₓ, from the vertical transport region to the at least one storage unit of the storage assembly.

2. The shelf robot of claim 1, wherein the manipulator assembly is further configured to move the item to be transported within the vertical transport region along a vertical linear axis A_{z}.

3. The shelf robot of claim 1, wherein the vertical transport region is located within a footprint of the base assembly.

4. The shelf robot of claim 1, wherein the first horizontal linear axis Aₓ is perpendicular to a main direction of movement of the shelf robot.

5. The shelf robot of claim 1, wherein the storage assembly comprises two or more storage units.

6. The shelf robot of claim 5, wherein a height of at least one of the storage units is adjustable manually or by a motor.

7. The shelf robot of claim 1, wherein the manipulator assembly comprises a telescopic gripper configured to grip the item to be transported.

8. The shelf robot of claim 7, wherein the telescopic gripper comprises gripping elements having an adjustable spacing.

9. The shelf robot of claim 1, wherein the manipulator assembly comprises a deposit area configured to support the item to be transported during storage or retrieval.

10. The shelf robot of claim 1, further comprising a housing assembly configured to accommodate the storage assembly and the manipulator assembly.

11. The shelf robot of claim 1, further comprising a sensor system configured to sense an environment of the shelf robot.

12. The shelf robot of claim 1, wherein the shelf robot is configured to operate autonomously or under control of a central unit.

13. A control device for a shelf robot, the shelf robot comprising a base assembly, a storage assembly, and a manipulator assembly, the control device comprising:
a memory storing instructions; and
a processor configured to execute the instructions to:
control the manipulator assembly to move an item to be transported along a first horizontal linear axis Aₓ from a shelf storage spot into a vertical transport region of the shelf robot; and
control the manipulator assembly to move the item to be transported along a second horizontal linear axis A_{y}, which is perpendicular to the first horizontal linear axis Aₓ, from the vertical transport region to at least one storage unit of the storage assembly.

14. The control device of claim 13, wherein the processor is further configured to control the manipulator assembly to move the item to be transported within the vertical transport region along a vertical linear axis A_{z}.

15. The control device of claim 13, wherein the vertical transport region is located within a footprint of the base assembly of the shelf robot.

16. The control device of claim 13, wherein the processor is further configured to control a telescopic gripper of the manipulator assembly to grip the item to be transported.

17. The control device of claim 16, wherein the processor is further configured to adjust a spacing between gripping elements of the telescopic gripper.

18. The control device of claim 13, wherein the processor is configured to control a sensor system of the shelf robot to sense an environment of the shelf robot.

19. The control device of claim 18, wherein the sensor system comprises one or more of a camera system, a LIDAR sensor, an ultrasonic sensor, or a light barrier.

20. A non-transitory computer-readable medium storing instructions that, when executed by a processor of a shelf robot comprising a base assembly, a storage assembly, and a manipulator assembly, cause the processor to:
control the manipulator assembly to move an item to be transported along a first horizontal linear axis Aₓ from a shelf storage spot into a vertical transport region of the shelf robot; and
control the manipulator assembly to move the item to be transported along a second horizontal linear axis A_{y}, which is perpendicular to the first horizontal linear axis Aₓ, from the vertical transport region to at least one storage unit of the storage assembly.
